(19) United States
(12) Patent Application Publication
(10) Pub. No.: US 2005/0224104 A1
(43) Pub. Date: Oct. 13, 2005

(54) Apparatus and method for cleaning a paint roller

(76) Inventor: Jeff Bleyaert, Dallas, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/820,481

(22) Filed: Apr. 8, 2004

(51) Int. Cl. B08B 7/04; B08B 3/12

(52) U.S. Cl. 134/151; 134/104.2; 134/198; 134/10; 134/34

(57) ABSTRACT

An apparatus and method for cleaning a paint roller, wherein the present apparatus is adapted to receive and substantially enclose a paint-soiled paint roller cover for the effective cleansing thereof via a pressurized cleaning fluid, and wherein the present invention permits the paint roller cover to remain on the wire frame of the paint roller assembly during the cleaning process; and wherein the present invention further effectively shields the user from paint spray (i.e., paint-soiled water or other solvent) during the cleansing process; all while providing for the effective drainage and containment of painted-soiled water leaving the paint roller cover during the cleaning process, thus reducing the quantity of cleaning fluid utilized and the duration of the overall cleaning process.

### TECHNICAL FIELD

The present invention relates generally to painting supplies and accessories, and more specifically to an apparatus and method for cleaning a paint roller, wherein the present invention, in conjunction with a pressurized cleaning fluid, enables the expeditious and convenient removal, containment, and disposal of paint from a paint roller, yet effectively shields the user from paint spray (i.e., paint-soiled water or other solvent) during the cleansing process.

### BACKGROUND OF THE INVENTION

Paint roller assemblies are commonly utilized by both professional painters and homeowners for fast and efficient painting of a selected surface. Most paint roller assemblies typically comprise a handle carrying a substantially cylindrically-shaped rotatable wire frame for the slidable receipt and retention of a cylindrically-shaped paint roller cover thereover. The paint roller cover is traditionally fabricated from an inner cardboard sleeve covered with a nap composed of selected tufted fibers, sheep skin, fabrics, sponges, or like, adapted to absorb or lift paint from a paint tray. The rotatable wire frame enables the paint roller cover to roll over a selected surface, and thus, evenly deposit and spread the absorbed paint thereover.

Following completion of a particular painting project, many painters or homeowners will clean and reuse the paint roller cover in an effort to reduce the overall cost of the painting project. Unfortunately however, proper and thorough cleaning of the paint roller cover is often difficult, burdensome and presents obvious ramifications. Specifically, if the paint roller is not thoroughly cleaned, vestigial paint residue will dry or harden and cause clumping of the roller nap, and thus, during subsequent reuse of the paint roller cover, result in an uneven spreading or painting pattern over a selected surface. Additionally, such dried paint residue may flake from the paint roller cover and either adulterate the fresh paint, or deposit onto the painted surface during contact of the paint roller cover therewith. Moreover, in those instances when a water-based, and thus water soluble, latex paint is utilized, common practice dictates the application of directing a flow of water over the paint roller cover to forcefully remove residual paint therefrom. However, such a process inescapably results in the splatter of paint, and is thus a characteristically messy method of cleaning. Cleaning and removing oil-based paints from paint roller covers requires the application of solvents thereto, wherein spillage or splatter of the solvents not only results in additional mess, but may further result in contamination of the environment and ground-water supply if utilized over earthen surfaces, or the potential ruination of indoor or non-earthen surfaces.

Although many paint roller cleaning assemblies are available, each present use and structural design limitations that render application of same highly impractical and inefficient. For instance, many available paint roller cover cleaning apparatuses require that the paint roller cover be removed from the wire frame of the paint roller assembly prior to cleaning same, wherein the paint roller cover is subsequently engaged over a rotational spindle apparatus housed within a bucket. Thereafter, a pressurized stream of cleaning fluid (i.e., water) is directed over the roller cover at a substantially oblique angle in an effort to forcefully drive or remove paint residue therefrom. The pressurized stream of cleaning fluid causes the roller cover engaged over the rotational spindle to rapidly spin about the spindle axis, and thus, receive the pressurized stream of cleaning fluid substantially thereover. Unfortunately however, because such devices require that the paint roller cover be removed prior to cleaning same, the user must remove the paint-soaked roller cover from the wire frame of the paint roller assembly, thereby subjecting his/her hands to wet paint, and thus exacerbating the overall cleaning process. Examples of such devices may be seen with reference to U.S. Pat. No. 4,311,158 to Harvey, U.S. Pat. No. 4,401,476 to Klaiber, U.S. Pat. No. 4,708,152 to Hibberd, U.S. Pat. No. 5,337,769 to Howe, and U.S. Pat. No. 5,409,027 to Glunt.

Still other devices are designed such that the paint roller cover may remain on the wire frame of the paint roller assembly during the cleaning process. Such devices typically include a cylindrical housing or tube possessing a diameter and length slightly greater than a conventional paint roller cover for facilitating reception of same within the housing. A water hose or similar water supply line may be secured to the housing for introducing water therewithin for washing the roller cover. Unfortunately however, in view of the small dimensional difference between the diameter of the cylindrical housing and the diameter of the paint roller cover, the narrow area between the inner wall of the housing and the external surface of the paint roller cover is insufficient for proper water flow and drainage of paint and water into a communicating collection reservoir, particularly in view of the continuous and pressurized stream of water directed across the roller cover. As such, a chaotic or turbulent paint-and-water mixture develops within the housing of such devices, wherein the paint-and-water mixture is constantly being propelled or reintroduced over the nap of the paint roller cover, therefore requiring excessive amounts of water to be directed thereover to ensure thorough cleaning of same.

Therefore, it is readily apparent that there is a need for an apparatus and method for cleaning a paint roller, wherein the present invention, in conjunction with a pressurized cleaning fluid, enables the expeditious and convenient cleansing of a paint-soiled paint roller cover, yet permits the paint roller cover to remain on the wire frame of the paint roller assembly during the cleaning process. There is a further need for such an apparatus that effectively shields the user from paint spray (i.e., paint-soiled water or other solvent) during the cleansing process, and further provides for the effective flow, drainage and containment of painted-soiled water (or other solvent) leaving the paint roller cover during the cleaning process.

### BRIEF SUMMARY OF THE INVENTION

Briefly described, in a preferred embodiment, the present invention overcomes the above-mentioned disadvantages and meets the recognized need for such a device by providing an apparatus and method for cleaning a paint roller, wherein the present apparatus is adapted to receive and substantially enclose a paint-soiled paint roller cover for the effective cleansing thereof via a pressurized cleaning fluid, and wherein the present invention permits the paint roller cover to remain on the wire frame of the paint roller assembly during the cleaning process; and wherein the present invention further effectively shields the user from paint spray (i.e., paint-soiled water or other solvent) during the cleansing process; all while providing for the effective drainage and containment of painted-soiled water leaving the paint roller cover during the cleaning process, thus reducing the quantity of cleaning fluid utilized and the duration of the overall cleaning process.

According to its major aspects and broadly stated, the present invention in its preferred form is an apparatus and method for cleaning a paint roller, comprising, in general, an enclosure and a collection reservoir.

More specifically, the present invention is an apparatus and method for cleaning a paint roller, comprising an approximately semi-elliptically-shaped enclosure adapted to cooperatively engage a collection reservoir, wherein an aperture formed through the enclosure is dimensioned to receive a paint roller cover therethrough. The front or forward wall of the enclosure is preferably dimensioned and configured such that upon engagement of the enclosure over the collection reservoir, a slot is formed between the lower or terminal edge of the front wall and the upper edge or rim of the collection reservoir. The slot is preferably sufficiently dimensioned to receive a pressurized stream of cleaning fluid (i.e., water or solvent) therethrough. Preferably, a collection channel or gutter is formed on the inner surface of the forward wall of the enclosure, preferably proximal to the terminal edge of the forward wall. As such, during application of a pressurized cleaning fluid, paint and cleaning fluid propelled against the inner surface of the forward wall is captured or collected by the gutter and channeled into the communicating collection reservoir. To stabilize the paint roller assembly during the cleansing process of the paint roller cover, a support cradle is disposed on top of the enclosure, wherein the wire support rod projecting transversely outwardly from one end of the rotatable wire frame may be seated and supported within the support cradle.

Accordingly, a feature and advantage of the present invention is its ability to effectively clean a paint roller cover, yet utilize sparing amounts of cleaning fluid as a result of the advantageous structural design and semi-elliptical shaped enclosure of the apparatus that enables the effective and enhanced flow and drainage of paint and cleaning solution during the cleaning process.

Another feature and advantage of the present invention is its incorporation of a gutter means for the effective capture and channeling of paint and cleaning solution into a communicating collection reservoir, thereby enhancing flow and drainage of paint and cleaning solution during the cleaning process.

Still another feature and advantage of the present invention is its incorporation of a gutter means for the effective capture and channeling of paint and cleaning solution into a communicating collection reservoir, thereby effectively shielding the user from undesirable paint spray during the cleaning process.

Yet another feature and advantage of the present invention is its structurally advantageous semi-elliptically-shaped enclosure for effectively shielding a user from undesirable paint spray during the cleaning process.

Still yet another feature and advantage of the present invention is its incorporation of an aperture formed through the enclosure, thereby facilitating the convenient introduction of a paint roller cover therethrough, while maintaining the paint roller cover over the rotatable wire frame of the paint roller assembly.

A further feature and advantage of the present invention is its incorporation of a support means for effectively stabilizing the paint roller assembly during the cleaning process.

Still a further feature and advantage of the present invention is its ability to enable the effective removal of water/latex-based paints and/or oil-based paints from a paint roller cover.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of an apparatus for cleaning a paint roller according to a preferred embodiment of the present invention;

FIG. 2 is a perspective view of an apparatus for cleaning a paint roller according to a preferred embodiment of the present invention, shown in use; and,

FIG. 3 is a side view of an apparatus for cleaning a paint roller according to a preferred embodiment of the present invention, shown in use.

### DETAILED DESCRIPTION OF THE PREFERRED AND SELECTED ALTERNATIVE EMBODIMENTS

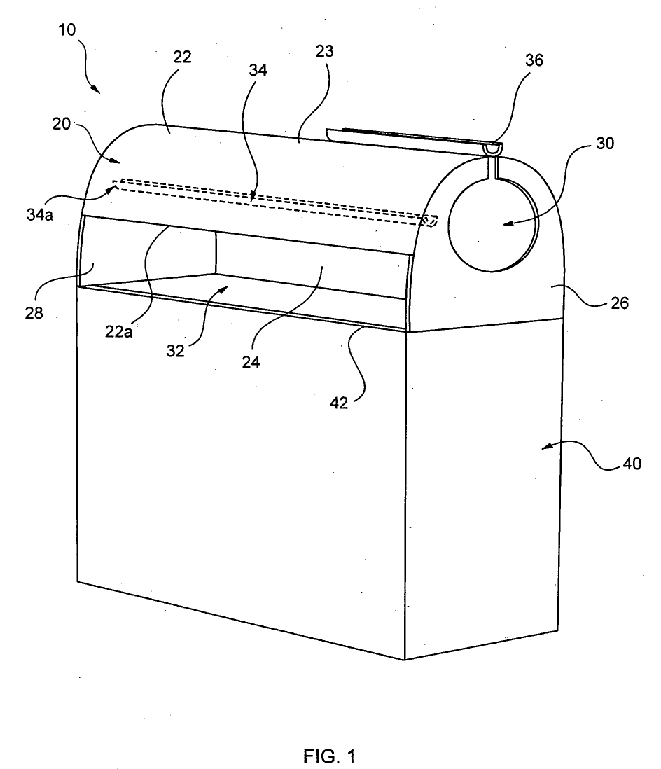

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is an apparatus 10 for cleaning a paint roller, comprising enclosure 20 and collection reservoir 40, wherein enclosure 20 is preferably cooperatively engageable to collection reservoir 40.

Specifically, enclosure 20 is preferably approximately semi-elliptically-shaped, comprising forward wall 22, rear wall 24 and sidewalls 26 and 28, wherein enclosure 20 is preferably dimensioned to receive and substantially enclose the full length of a conventional paint roller cover C. Preferably centrally formed through sidewall 26 is aperture 30, wherein aperture 30 preferably comprises a sufficiently dimensioned diameter to readily receive any selected type, size and/or diameter of paint roller cover C therethrough.

Preferably, upon cooperative engagement of enclosure 20 with bucket-like collection reservoir 40, rear wall 24 and sidewalls 26 and 28 form a substantially sealed and frictional fit with upper edge or rim 42 of collection reservoir 40. However, forward wall 22 of enclosure 20 is preferably dimensioned and configured such that upon engagement of enclosure 20 over collection reservoir 40, window or slot 32 is preferably formed between lower or terminal edge 22a of forward wall 22 and rim 42 of collection reservoir 40. Slot 32 is preferably sufficiently dimensioned to receive a pressurized stream of cleaning fluid CF (i.e., water or other solvent) therethrough for the cleaning of paint roller cover C, as more fully described below.

Preferably, collection channel or gutter 34 is formed on inner surface 22b of forward wall 22 of enclosure 20, preferably proximal to terminal edge 22a of forward wall 22. Specifically, gutter 34 preferably extends from sidewall 26 of enclosure 20, spans the majority of the length of forward wall 22, but stops just short of sidewall 28, thereby creating a “drop off” or ledge 34a from which collected paint and cleaning fluid may be relieved or drained. Additionally, gutter 34 is preferably disposed at a slight downward slant or angle relative to terminal edge 22a of forward wall 20, thereby promoting the gravitational drainage of collected paint and cleaning fluid from ledge 34a and into collection reservoir 40 during the cleaning process. That is, and as more fully described below, during application of a pressurized cleaning fluid, paint and cleaning fluid propelled against inner surface 22b of forward wall 22 is captured or collected by gutter 34 and channeled into the communicating collection reservoir 40.

To stabilize the paint roller assembly P during the cleansing process of paint roller cover C, an approximately U-shaped support cradle 36 is preferably disposed on top surface 23 of enclosure 20, proximal sidewall 26, wherein wire support rod R projecting transversely outwardly from one end of rotatable wire frame F of paint roller assembly P may be seated and supported upon support cradle 36 following insertion of paint roller cover C through aperture 26 of sidewall 26, and during the cleaning process of same.

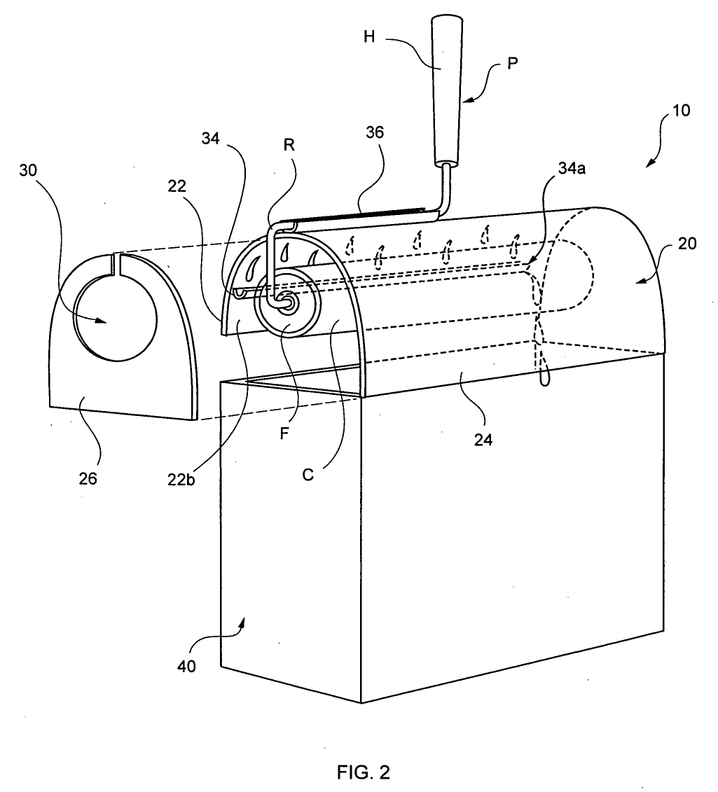

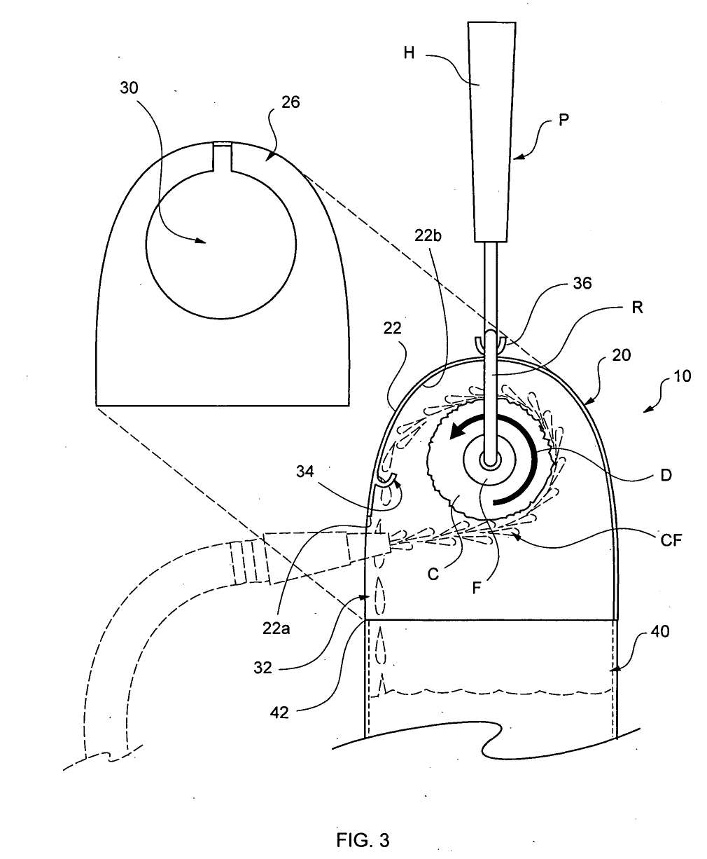

Referring now more specifically to FIGS. 2-3, in use, a user preferably grasps handle H of paint roller assembly P, and guides or introduces paint-soiled paint roller cover C through aperture 30 of enclosure 20, wherein paint roller cover C preferably remains over the underlying rotatable wire frame F during the cleansing process, and wherein wire support rod R is preferably seated and supported on support cradle 36 (sidewall 26 is shown removed in FIGS. 2-3 for purpose of clarity). Upon directing a stream of pressurized cleaning fluid CF through slot 32 of enclosure 20, and as a result of a user introduced oblique angle at which the pressurized cleaning fluid CF may be brought to contact and forcefully act on the lower portion of paint roller cover C, paint roller cover C may be forcibly rotated and rapidly spun about the axis of rotatable wire frame F, preferably in a direction D toward inner surface 22b of forward wall 22 of enclosure 20. In such a rapidly spinning state, and in conjunction with the continuous, directed, and pressurized stream of cleaning fluid CF, paint is forcefully removed from paint roller cover C and, in conjunction with the paint-soiled cleaning fluid CF, collected within the communicating collection reservoir 40. Moreover, paint and cleaning fluid forcefully propelled against inner surface 22b of shield-like forward wall 22 of enclosure 20 is preferably captured or collected within gutter 34 of enclosure 20, and subsequently channeled into collection reservoir 40.

It is contemplated within an alternate embodiment that rim 42 of collection reservoir 40 could incorporate a clasp or other suitable retaining clamp for removably securing a water hose or the like thereto. In such an embodiment, it is further contemplated that the retaining clamp could be slidably engaged to rim 42 so as to enable the clamped water hose to be slidably moved along rim 42 for redirecting or concentrating the expelled cleaning fluid/water over a particular area of the paint roller cover C.

It is further contemplated in an alternate embodiment that collection reservoir may include drainage spouts for coupling same to a suitable municipal or environmentally-approved drainage reservoir.

It is further contemplated that a suitably slotted mesh screen or body of densely-packed bristles may extend downwardly from terminal edge 22a of forward wall 22 and over slot 32, thereby permitting a water hose nozzle head, or the like, to be introduced therethrough for delivery of pressurized cleaning fluid across paint roller cover C, yet effectively protect and shield the user from any back spray of paint that may exist through slot 32.

It is still further contemplated that enclosure 20 may comprises a suitable soap or solvent dispensing mechanism for dispensing select quantities of soap, solvents and/or other paint-removing surfactants during the cleansing process.

It is yet further contemplated that support cradle 36 could comprise a snap-shut or latchable cover with suitable internal padding or other conforming or conformable material so as to effectively clamp wire support rod R therebetween and thus, provide the hands-free support of paint roller assembly P thereby.

In still another alternate embodiment, it is contemplated that enclosure 20 could comprise scrubbing bristles or similar textured surfaces formed on the internal surfaces thereof, thereby permitting a user to scrub paint roller cover C thereover during the cleaning process, or, alternatively, permitting paint roller cover C to contact the scrubbing surfaces during rapid rotation of paint roller cover C as more fully described above.

In still yet another alternate embodiment it is contemplated that enclosure 20 could comprise an integrally formed slot for enabling the passage of a pressurized cleaning fluid therethrough.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An apparatus for cleaning a paint roller cover, said apparatus comprising:
an enclosure comprising an aperture dimensioned to receive the paint roller cover therethrough, wherein cooperative engagement of said enclosure with a collection reservoir yields a slot through which a pressurized cleaning fluid may be directed for contacting the paint roller cover for removal of paint therefrom.

2. The apparatus of claim 1, wherein said enclosure comprises a gutter means carried therewithin, said gutter means adapted to capture, collect, and channel into said collection reservoir at least a portion of cleaning fluid and paint forcefully propelled from the paint roller cover.

3. The apparatus of claim 2, wherein said enclosure comprises a support cradle disposed thereon, said support cradle adapted to support at least a portion of a wire support rod extending from a rotatable wire frame upon which the paint roller cover is engaged.

4. The apparatus of claim 3, wherein said support cradle comprises a removably securable cover comprising a conformable material disposed therewithin for effectively clamping the wire support rod therebetween and thus, provide the hands-free support of a paint roller assembly thereby.

5. The apparatus of claim 1, wherein said enclosure is approximately semi-elliptically shaped.

6. The apparatus of claim 1, wherein said enclosure comprises a textured scrubbing surface disposed over at least a portion of the inner surface of said enclosure, said textured scrubbing surface enabling a user of said apparatus to engage and scrub the paint roller cover thereover during the cleaning process, or enable the paint roller cover to contact said textured scrubbing surface during rapid rotation of the paint roller cover as a result of the pressurized cleaning fluid directed thereover, and thus enable the scrubbing thereof.

7. The apparatus of claim 1, wherein said enclosure comprises scrubbing bristles disposed over at least a portion of the inner surface of said enclosure, said scrubbing bristles enabling a user of said apparatus to engage and scrub the paint roller cover thereover during the cleaning process, or enable the paint roller cover to contact said scrubbing bristles during rapid rotation of the paint roller cover as a result of the pressurized cleaning fluid directed thereover, and thus enable the scrubbing thereof.

8. The apparatus of claim 1, wherein said enclosure comprises a slotted mesh screen adapted to extend downwardly over said slot, thereby permitting a hose nozzle head to be introduced therethrough for delivery of pressurized cleaning fluid across the paint roller cover, yet effectively protect and shield the user from any back spray of paint that may exist through said slot.

9. The apparatus of claim 1, wherein said enclosure comprises a body of densely-packed bristles adapted to extend downwardly over said slot, thereby permitting a hose nozzle head to be introduced therethrough for delivery of pressurized cleaning fluid across the paint roller cover, yet effectively protect and shield the user from any back spray of paint that may exist through said slot.

10. The apparatus of claim 1, wherein said collection reservoir comprises a retaining clamp slidably disposed thereon for removably securing a hose thereto, wherein said retaining clamp may be selectively slidable moved for redirecting or concentrating cleaning fluid expelled from the hose over a selected area of the paint roller cover.

11. The apparatus of claim 1, wherein said collection reservoir comprises drainage spouts.

12. The apparatus of claim 1, further comprising a soap or solvent dispensing mechanism for dispensing select quantities of soap, solvents or other paint-removing surfactants during the cleansing process.

13. An apparatus for cleaning a paint roller cover, said apparatus comprising:
an enclosure comprising an aperture dimensioned to receive the paint roller cover therethrough, wherein said enclosure comprises a gutter means carried therewithin, said gutter means adapted to capture, collect, and channel into a collection reservoir at least a portion of cleaning fluid and paint forcefully propelled from the paint roller cover as a result of a pressurized cleaning fluid forcefully directed thereover.

14. The apparatus of claim 13, wherein said enclosure is cooperatively engageable with said collection reservoir, and wherein cooperative engagement of said enclosure with said collection reservoir yields a slot through which the pressurized cleaning fluid may be directed for contacting the paint roller cover for removal of paint therefrom.

15. The apparatus of claim 14, wherein said enclosure comprises a support cradle disposed thereon, said support cradle adapted to support at least a portion of a wire support rod extending from a rotatable wire frame upon which the paint roller cover is engaged.

16. The apparatus of claim 15, wherein said support cradle comprises a removably securable cover comprising a conformable material disposed therewithin for effectively clamping the wire support rod therebetween and thus, provide the hands-free support of a paint roller assembly thereby.

17. The apparatus of claim 13, wherein said enclosure is approximately semi-elliptically shaped.

18. The apparatus of claim 13, wherein said enclosure comprises a textured scrubbing surface disposed over at least a portion of the inner surface of said enclosure, said textured scrubbing surface enabling a user of said apparatus to engage and scrub the paint roller cover thereover during the cleaning process, or enable the paint roller cover to contact said textured scrubbing surface during rapid rotation of the paint roller cover as a result of the pressurized cleaning fluid directed thereover, and thus enable the scrubbing thereof.

19. The apparatus of claim 13, wherein said enclosure comprises scrubbing bristles disposed over at least a portion of the inner surface of said enclosure, said scrubbing bristles enabling a user of said apparatus to engage and scrub the paint roller cover thereover during the cleaning process, or enable the paint roller cover to contact said scrubbing bristles during rapid rotation of the paint roller cover as a result of the pressurized cleaning fluid directed thereover, and thus enable the scrubbing thereof.

20. The apparatus of claim 13, wherein said enclosure comprises a slotted mesh screen adapted to extend downwardly over said slot, thereby permitting a hose nozzle head to be introduced therethrough for delivery of pressurized cleaning fluid across the paint roller cover, yet effectively protect and shield the user from any back spray of paint that may exist through said slot.

21. The apparatus of claim 13, wherein said enclosure comprises a body of densely-packed bristles adapted to extend downwardly over said slot, thereby permitting a hose nozzle head to be introduced therethrough for delivery of pressurized cleaning fluid across the paint roller cover, yet effectively protect and shield the user from any back spray of paint that may exist through said slot.

22. The apparatus of claim 13, wherein said collection reservoir comprises a retaining clamp slidably disposed thereon for removably securing a hose thereto, wherein said retaining clamp may be selectively slidable moved for redirecting or concentrating cleaning fluid expelled from the hose over a selected area of the paint roller cover.

23. The apparatus of claim 13, wherein said collection reservoir comprises drainage spouts.

24. The apparatus of claim 13, further comprising a soap or solvent dispensing mechanism for dispensing select quantities of soap, solvents or other paint-removing surfactants during the cleansing process.

25. The apparatus of claim 13, wherein said enclosure comprises a slot formed therethrough for enabling the introduction of cleaning fluid therethrough.

26. A method of preventing reintroduction of paint and cleaning fluid over a paint-soiled paint roller cover being cleaned within a paint roller cleaning apparatus by a pressurized cleaning fluid directed thereover, said method comprising the steps of:
a. incorporating a gutter means within said paint roller cleaning apparatus;
b. permitting paint and cleaning fluid forcefully propelled from the paint roller cover by the pressurized cleaning fluid to be captured and collected by said gutter means; and,
c. permitting the captured and collected paint and cleaning fluid within said gutter means to drain into a collection reservoir.
